(19) United States
(12) Patent Application Publication
(10) Pub. No.: US 2003/0028449 A1
(43) Pub. Date: Feb. 6, 2003

(54) Capital equipment on-line configurator interface

(75) Inventors: John Heinen, Wauwatosa, WI (US); David L. Ziler, Oconomowoc, WI (US)

Correspondence Address: Marcus W. Sprow, FOLEY & LARDNER, Firstar Center, 777 East Wisconsin Avenue, Milwaukee, WI, 53202-5367, US

(73) Assignee: GE Medical Systems Global Technology Co., LLC.

(21) Appl. No.: 09/920,261

(22) Filed: Aug. 1, 2001

(51) Int. Cl. G06F 17/60

(52) U.S. Cl. 705/27; 705/37

(57) ABSTRACT

A system for and method of configuring capital equipment in an on-line marketplace environment provides for the generation and acceptance of purchase orders in an automated and distributed environment. Using this system or method, a purchaser may view basic product information at a business-to-business exchange web page and select a link to display a product provider web page. After the purchaser contacts the product provider to configure a particular capital equipment product, the product provider posts a complete product specification and price quotation on-line at the product provider web page. A reference to the quote is displayed at the exchange web page, and the purchaser may view the quotation on-line and accept the quotation at the exchange web page.

### FIELD OF THE INVENTION

The present invention relates to distributed computer systems. More particularly, the present invention relates to a capital equipment on-line configurator interface.

### BACKGROUND OF THE INVENTION

The configuration of capital equipment products is a complicated process that is difficult to capture in an on-line, automated environment. Capital equipment products generally require extensive customization based on individual purchaser requirements. Sales of capital equipment therefore typically require detailed discussions with the customer's purchase agent to determine the types of applications, components, and performance characteristics needed for a particular use.

For example, to properly configure a magnetic resonance (MR) scanner to meet the needs of a particular purchaser, it would be beneficial for the sales representative of a product provider (e.g., manufacturer, supplier, vender, etc.) to know the number and type of peripheral devices that will be used with the scanner, the desired power output, the physical dimensions of the space in which the scanner will be used, whether the purchaser has in-house service capability, and the types of tests and applications for which the scanner will be used. Each of these configuration inputs may result in the addition, subtraction, or modification of components or applications included in the scanner.

Once the sales representative determines the capital equipment configuration best suited to a given purchaser's requirements, the purchaser has an opportunity to review the configuration and perhaps order the capital equipment product. Typically, the sales representative generates a written price quotation that is sent to the purchaser, who then signs the quotation to accept what is effectively an offer to sell the of capital equipment product at the stated price. The use of paper price quotations and acceptances is a slow process that results in delays to the order.

Since questions designed to elicit purchaser requirements for capital equipment products tend to be fairly detailed, human intervention is generally required at some point in the order process. With the advent of electronic commerce, on-line business-to-business exchanges may be used to supplement the procedure currently used to purchase capital equipment products. These exchanges may operate as on-line marketplaces that include basic product information for a variety of products and product providers. Thus, a purchaser may use a web browser to view a web page that acts as a business-to-business exchange for medical equipment or the like. The purchaser may then select a particular piece of capital equipment, such as an MR scanner, and a list of product providers and their respective products would be displayed.

One difficulty in the use of business-to-business exchanges for orders of capital equipment products pertains to the nature of the products. Since extensive configuration is required, a potential purchaser typically must deal directly with the product provider either through telephonic, written, or electronic communications that take place outside of the exchange. If the purchaser is interested in a variety of products, keeping track of dealings with various product providers may be difficult, in that price quotation and order status information are not centralized for easy reference. Additionally, each product provider may have a different procedure that the purchaser must follow to accept a given price quotation, resulting in additional effort on behalf of the purchaser.

Another difficulty is that once the purchaser leaves the business-to-business exchange to visit a product provider web page or speak personally with a sales representative, the exchange receives no additional information from the purchaser or the product provider. The exchange thus plays no role in the capital equipment purchase beyond that of an advertising medium for product providers to display their wares. As such, the exchange cannot track whether or not a sale of a particular product has occurred or provide any other useful services for purchasers. Once a purchaser establishes relationships with one or more product providers, then, there may be no reason for the purchaser to revisit the exchange.

Thus, there is a need for an enhanced on-line capital equipment purchase system. There is a further need to provide an on-line method of issuing price quotations to a purchaser and receiving an acceptance of the price quotation from the purchaser. There is still a further need to provide a uniform and centralized method of displaying and accepting price quotations in a capital equipment product purchase process. There is yet a further need to provide an on-line business-to-business exchange having a variety of features designed to assist capital equipment purchasers.

The teachings here and below extend to those embodiments which fall within the scope of the appended claims, regardless of whether they accomplish one or more of the above-mentioned needs.

### SUMMARY OF THE INVENTION

An exemplary embodiment relates to a system for purchasing customized capital equipment in an online marketplace environment. The system includes a business-to-business exchange web page that has basic product information for a plurality of capital equipment products. The system further includes at least one link on the exchange web page for punching through from the exchange web page to a product provider web page. Finally, the system includes means for presenting a price quotation for a capital equipment product and an acceptance module configured for enabling acceptance of the price quotation at the exchange web page.

Another exemplary embodiment relates to a system for allowing purchases of customized capital equipment in a marketplace environment. The system includes a business-to-business exchange web page that includes basic product information for at least one product and at least one link to a product provider web page. The system also includes means for displaying a price quotation from a product provider at the exchange web page and means for accepting the price quotation at the exchange web page.

Yet another exemplary embodiment relates to a method for purchasing customized capital equipment products in an electronic marketplace. The method includes viewing basic product information for a plurality of capital equipment products at a business-to-business exchange. The method also includes providing customer specifications for a customized capital equipment product to a product provider, viewing a price quotation for the customized capital equipment product, and accepting the price quotation at the business-to-business exchange.

A further exemplary embodiment relates to a method for enabling purchases of customized capital equipment in a marketplace environment. The method includes displaying basic product information for a plurality of products at a business-to-business exchange web page and providing at the exchange web page a link to a price quotation for a capital equipment product. The method also includes receiving an acceptance of the price quotation at the exchange web page.

Yet still a further exemplary embodiment relates to a method for enabling purchases of customized capital equipment in a marketplace environment. The method includes displaying basic product information for a capital equipment product at a business-to-business exchange and providing at the exchange a link to a customized price quotation for a capital equipment product. The method also includes receiving an acceptance of the price quotation at the exchange and communicating the acceptance to a product provider.

Other features and advantages of embodiments of the present invention will become apparent to those skilled in the art upon review of the following drawings, the detailed description, and the appended claims.

### BRIEF DESCRIPTION OF THE DRAWINGS

The exemplary embodiments will hereafter be described with reference to the accompanying drawings, wherein like numerals denote like elements, and:

FIG. 1 is a diagrammatical representation of a system for purchasing customized capital equipment in an online marketplace environment according to an exemplary embodiment;

FIG. 2 is a flow diagram illustrating a method of capital equipment configuration according to an exemplary embodiment; and

FIG. 3 is an illustration of a business-to-business exchange web page according to an exemplary embodiment.

### DETAILED DESCRIPTION OF THE EXEMPLARY EMBODIMENTS

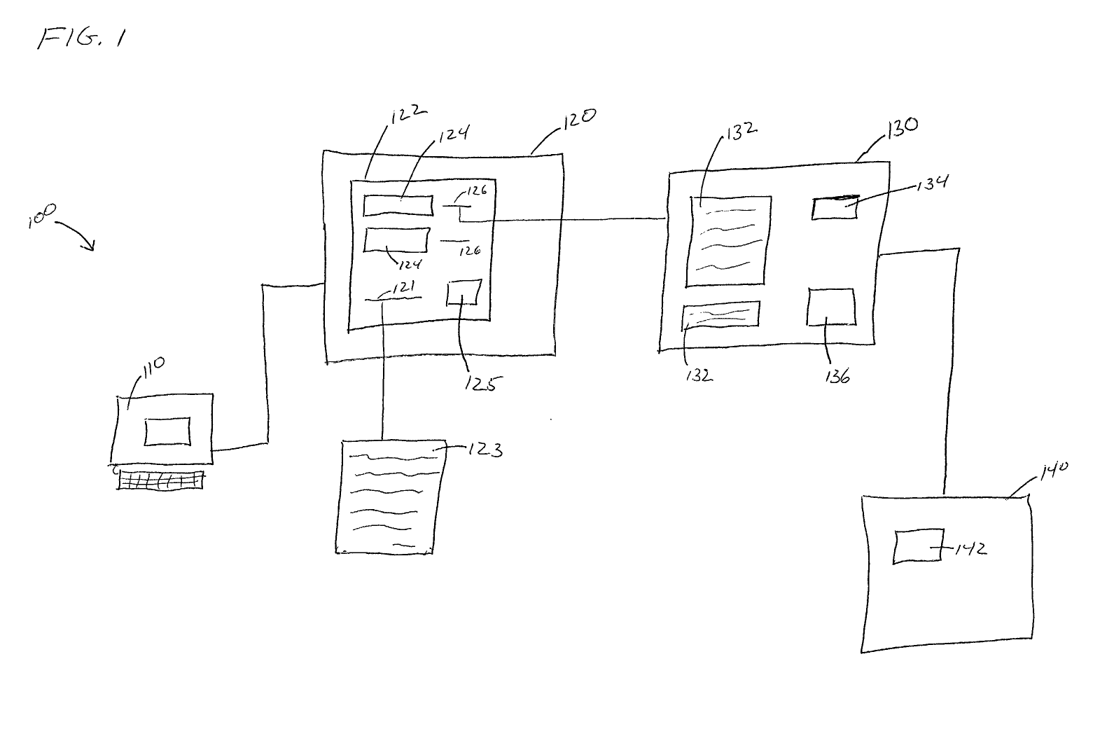

FIG. 1 illustrates a system 100 for purchasing customized capital equipment in an online marketplace environment according to an exemplary embodiment. To purchase capital equipment, a potential customer or purchaser of capital equipment accesses a business-to-business exchange 120 using a computer 110. The purchaser may be a purchase agent for a company or an individual purchaser. According to an exemplary embodiment, computer 110 is a personal computer including a modem, Ethernet connection, or other device for connecting to the Internet so as to enable on-line communication between computer 110 and remote Internet web pages. In alternative embodiments, the purchaser may access exchange 120 using other electronic devices, such as, but not limited to, personal digital assistants, cellular telephones, or other such devices configured to enable communication with Internet web pages. The connection between computer 110 or other electronic devices and the Internet may be a wireless or traditional wired connection.

Business-to-business exchange 120 acts as an on-line marketplace for a variety of capital equipment product providers (e.g., manufacturers, suppliers, vendors, etc.). In an exemplary embodiment, exchange 120 includes an Internet web page 122 that may be accessed by any device having a connection to the Internet and the capability of interfacing (visually or audibly) with Internet web pages. For example, the purchaser may view the contents of exchange web page 122 by utilizing a web browser application included in computer 110. In an alternative embodiment, exchange 120 may include an electronic bulletin board system (BBS).

In an exemplary embodiment, exchange web page 122 includes basic or general product information 124 for a variety of capital equipment products offered by a number of product providers. In this manner, exchange web page 122 acts as an on-line marketplace for capital equipment products by allowing purchasers to view a variety of products in a single location. Basic product information 124 may include an estimated or budgetary price for a particular capital equipment product, and may also include descriptions or specifications of base model configurations that may be modified depending on requirements specified by the purchaser. For example, in the case of capital equipment for use in a medical environment, basic product information 124 for an MR scanner may include a price for a base model configured for use with typical hospital systems. Product specifications, such as power output, types of peripheral devices or applications included in the unit, physical size, and other information may also be included in basic product information 124. The amount and type of information 124 included in exchange web page 122 will depend on the type of capital equipment product involved and the overall customizability of the product. That is, products that include a large number of customization options may include less information 124 than those products that include fewer options, since most of the product configuration will depend on purchaser requirements.

Exchange web page 122 may include hyperlinks or links 126 for allowing a purchaser to punch through to a product provider web page 130. After viewing basic product information 124 at exchange web page 122, a purchaser may desire to receive more specific information and initiate contact with the product provider. Activating a link 126 to provider web page 130 serves as a shortcut for displaying product provider web page 130 on computer 110. In the absence of link 126, the purchaser may type in the product provider web page address or use any of a variety of other means for requesting the display of provider web page 130.

Information included in provider web page 130 may include detailed product information 132; contact information 134 such as phone numbers, addresses, or electronic mail (e-mail) addresses for customer service or sales representatives; or other information. Provider web page 130 may further include a module 136 for determining purchaser capital equipment needs. Module 136 may be configured for providing the purchaser with a series of questions regarding various potential uses and requirements for the capital equipment product. Answers provided by the purchaser may be used to automatically generate a complete product price quotation for a product suited to the unique needs of the purchaser.

In an exemplary embodiment, the answers are used by a product provider sales representative in generating a price quotation. In some cases, capital equipment products involve a series of complicated configuration issues which require human intervention. In these cases, the purchaser contacts a product provider sales representative via telephone or e-mail and the sales representative asks additional questions to aid in determining specific purchaser needs and in configuring the product appropriately. Thus, both module 136 and the sales representative may elicit information for use in generating a quotation. In an alternative embodiment, module 136 is not used, and all configuration information is elicited by a sales representative.

Provider web page 130 is associated with a product provider computer system 140. In an exemplary embodiment, computer system 140 includes a server, a database, computer software, and modems or other hardware configured for providing an interface between computer system 140 and the Internet. Computer system 140 also includes a capital equipment configurator module 142 for tailoring capital equipment products to specific purchaser requirements. Configurator 142 enables a sales representative to enter a variety of information pertaining to purchaser needs and to generate a complete product configuration and price quotation. For example, a purchaser of an MR scanner may require a magnetic flux density of at least 1.2 Tesla. If the product provider offers a 1.0 Tesla scanner and a 1.5 Tesla scanner, configurator 142 recommends the 1.5 Tesla scanner to meet the customer requirement. Especially in cases where a product includes a variety of options, configurator 142 may greatly reduce instances of improper product configurations. For example, configurator 142 may include a module designed to ensure that only compatible components are included in a customized product. If two options for a given capital equipment product are mutually exclusive, configurator 142 displays a message that the two components could not both be included in the same product.

Exchange web page 122 may include a hyperlink 121 to a customized price quotation 123. Price quotation 123 may be included as part of provider web site 130, in which case link 121 would connect exchange web page 122 with provider web page 130. In this embodiment, a purchaser may view price quotation 123 either by activating link 121 or by visiting provider web page 130 directly. In an alternative embodiment, price quotation 123 may be stored on exchange web page 122 or elsewhere in exchange 120. In yet another alternative embodiment, price quotation 123 may be stored in any other location accessible by a link from exchange web page 122, including a separate web page, product provider computer system 140, or another computing device.

Price quotation 123 may include a complete description of a capital equipment product customized to purchaser requirements. Price quotation 123 may also include an exact price for the customized product. In an exemplary embodiment, price quotation 123 may constitute an offer to sell the customized product at the specified price, and the acceptance of price quotation 123 by a purchaser forms a binding contractual agreement.

To facilitate acceptance of price quotation 123 by a purchaser, exchange 120 includes an acceptance module 125 configured for allowing acceptance of price quotation 123 by a purchaser. In an exemplary embodiment, module 125 allows the purchaser to accept price quotation 123 without leaving exchange web page 122. For example, module 125 may include a button or link 128 labeled with the words “accept quotation” or the like, and activating the button by clicking would effect an acceptance of price quotation 123. One advantageous feature of this exemplary embodiment is that the purchaser need not display product provider web page 130 or fill out paper forms to accept price quotation 123. Acceptance by the purchaser at exchange web page 122 may also automatically produce an acceptance at product provider web page 130. Thus, the acceptance is received both by exchange web page 122 and provider web page 130 simultaneously. One advantageous feature of this embodiment is that both the exchange 120 and product provider will be instantly aware when an acceptance of price quotation 123 has occurred.

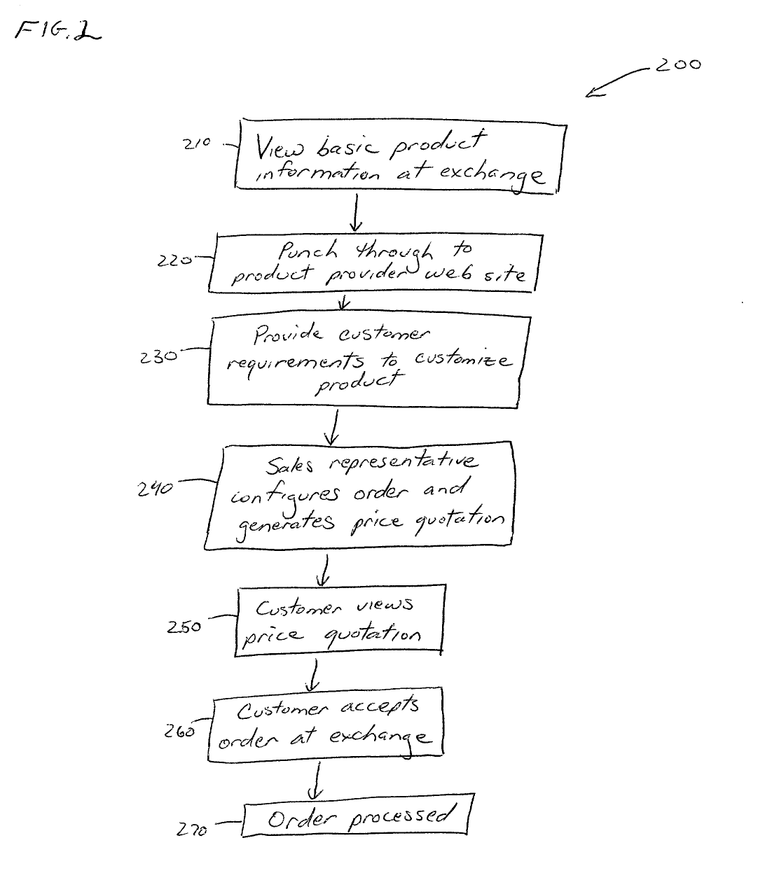

FIG. 2 is a flow diagram 200 illustrating a method of configuring a capital equipment product according to an exemplary embodiment. In a step 210, a purchaser is presented with basic product information 124 included in business-to-business exchange web page 122. In an exemplary embodiment, the purchaser views web page 122 using a personal computer having a web browser and means for connecting to the Internet.

In a step 220, the purchaser activates a hyperlink 126 to punch through to a product provider web page 130 to obtain additional information about a particular capital equipment product and initiate the price quotation process. In an alternative embodiment, activating the hyperlink may cause a new web browser window to open, and product information and details will be provided in the new web browser window.

To create price quotation 123 for a customized capital equipment product based on specific purchaser requirements, information from the purchaser is provided to the product provider in a step 230. To convey the specific requirements to the product provider, a variety of methods may be used. In an exemplary embodiment, the purchaser may speak with a product provider sales representative using a telephone. In this embodiment, the sales representative asks the purchaser a series of questions designed to elicit information pertaining to specific purchaser requirements. For example, a purchaser may wish to modify a basic MR scanner to conform to a particular set of power output requirements. Other modifications may include providing connections for various peripheral devices, installing applications designed to perform various functions, or adapting the scanner to conform to a physical space by rearranging scanner components. The number and type of modifications allowed for a particular product will vary depending on the product.

Product provider web page 130 may include a module 136 configured for automatically eliciting information from a purchaser. In this embodiment, module 136 includes questions regarding purchaser needs and blank fields in which the purchaser may type answers to the questions. The answers to these questions may be used by the sales representative in generating the equipment configuration. In an alternative embodiment, module 136 may be used to automatically elicit all necessary information from the purchaser, after which price quotation 123 may be automatically generated.

After the purchaser requirements are determined, a product provider sales representative generates a price quotation 123 in a step 240. To generate price quotation 123, the sales representative uses configurator 142 to optimally configure a customized capital equipment product designed to meet purchaser requirements. Configurator 142 may be a COBRA configurator or any other system designed to configure capital equipment. In an alternative embodiment, price quotation 123 is automatically generated in response to requirements entered by the purchaser in response to questions generated by module 136. Such an automatic system may utilize neural networks or other artificial intelligence techniques.

A reference in the form of a hyperlink to price quotation 123 is then placed on exchange web page 122 to allow a purchaser to review price quotation 123. In a step 250, the purchaser may then reviews the price quotation by displaying exchange web page 122 and selecting price quotation hyperlink 121. The purchaser may thus use exchange web page 122 to keep track of a variety of purchase transactions. That is, a purchaser viewing exchange web page 122 is instantly aware that a price quotation from a particular product provider is available. This saves the purchaser the effort of continually checking various product provider web pages or contacting the product providers directly. In an alternative embodiment designed to simplify the purchase process further, price quotation 123 may be viewed directly at exchange web page 122, saving the purchaser additional time in waiting for provider web page 130 to be displayed on computer 110.

In a step 260, the purchaser may then accept price quotation 123 at exchange web page 122. The acceptance may be effected by selecting button 128. The order is processed in a step 270 by notifying the product provider of the acceptance. This notification may include sending an electronic notification to the product provider. The notification may also include triggering an acceptance at product provider web page 130. After being notified, the product provider will produce a customized capital equipment product and deliver the product to the purchaser.

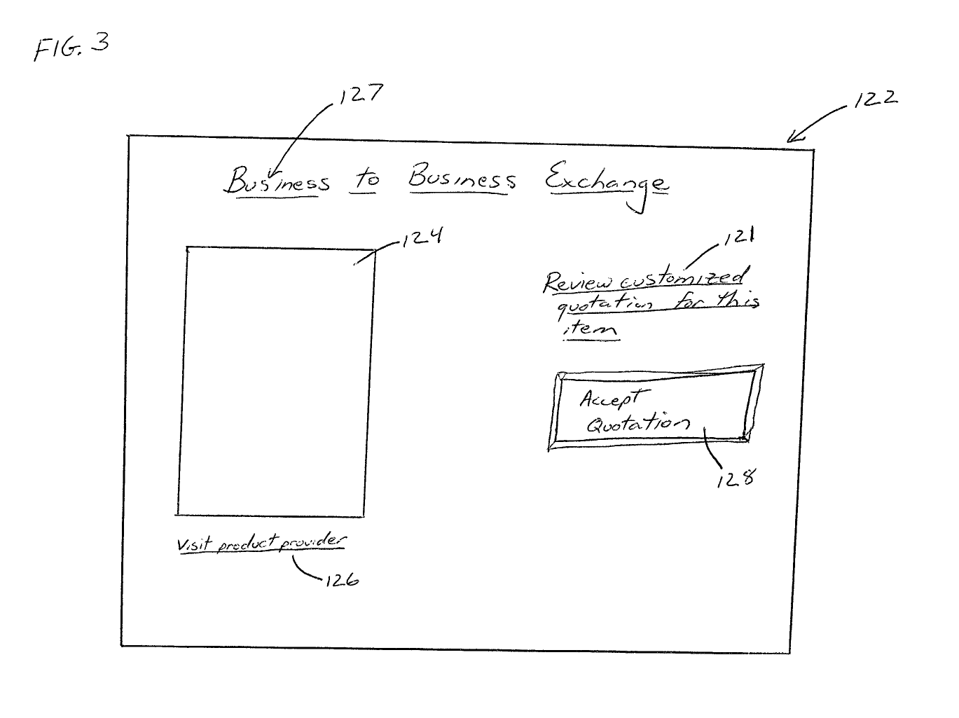

FIG. 3 is an illustration of a business-to-business exchange web page 122 according to an exemplary embodiment. Web page 122 may be presented to a purchaser using a web browser, and may include a logo or icon 127 associated with business-to-business exchange 120. Included in web page 122 is basic product information 124 and a hyperlink 126 to product provider web page 130. Conventionally, a purchaser may use a mouse, touchpad, or other pointing device to move a cursor, arrow, or other icon over hyperlink 126. The purchaser may then click or otherwise select hyperlink 126, after which product provider web page 130 is presented. In an exemplary embodiment, provider web page 130 replaces exchange web page 122 in the web browser window. Alternatively, a new web browser or web browser window may be opened and provider web page 130 may be displayed therein.

Exchange web page 122 also includes hyperlink 121 to price quotation 123 generated by the product provider. The same method for selecting hyperlink 121 may be used as described above in conjunction with hyperlink 126. Selecting hyperlink 121 causes price quotation 123 to be displayed in the current web browser window or alternatively in a new web browser window. Price quotation 123 may include complete product specifications and an exact purchase price, and may constitute an offer to sell the product as configured at the specified price. Exchange web page 122 also includes button 128, the selection of which operates as an acceptance of price quotation 123 by the purchaser. In an exemplary embodiment, acceptance module 125 automatically sends an acceptance notification to the product provider when button 128 is selected. A notification to product provider web site 130 may also be automatically sent at this time. In an alternative embodiment, upon selecting button 128, acceptance module 125 may be configured to present the purchaser with additional forms or information. Thus, a user selecting button 128 may be presented with a confirmation form that must be filled out with relevant information before an acceptance can take place.

Other layouts and designs for web page 122 may also be used. Individual components may also be arranged and designed differently depending on the particular application involved. In the exemplary embodiment of FIG. 3, information 124, hyperlinks 121 and 126, and button 128 concern a particular product of a single product provider. In another embodiment, information for many products from different product providers may be presented in exchange web page 122. In another embodiment, web page 122 may be divided into multiple sections. One section may include basic product information 124 for a particular product and a link 126 to the product provider associated with that product, while another section may include links 121 and buttons 128 for a number of different price quotations 123. In this manner, a purchaser may use exchange web page 122 to view information 124 for different products while keeping track of a number of price quotations 123 for other products.

Advantageously, the method described allows a product provider to receive configuration requests from any number of business-to-business exchanges and other sites with which the manufacturer decides to integrate. Thus, the same modules designed to display price quotations for purchaser review and receive acceptances from the exchange may be used in a variety of exchanges, allowing for uniformity of the process and ease of administration for the product provider. A related benefit is that one system can be used to generate price quotations 132 and receive acceptances, regardless of the type of capital equipment at issue. Thus, the same method could be used for MR scanners and ultrasound equipment, with the only difference coming at the product provider configuration level. Price quotation 123 would be viewed and accepted in the same manner for each product.

Another advantageous feature of the method described is that the customer is directed from exchange 120 to product provider web page 130 after viewing basic product information at exchange 120. An opportunity is thus provided for the potential purchaser to view other items offered for sale by the product provider. Yet another advantage is that acceptance of the order is controlled at exchange web page 122, which allows a purchaser to use exchange 120 as a consolidator of various purchase transaction information. This also allows the exchange to track product sales and provide other information to purchasers.

While the embodiments illustrated in the figures and described above are presently preferred, it should be understood that these embodiments are offered by way of example only. Other embodiments may include additional procedures, steps, or components not described here. For example, additional measures, such as password protection or the like, may be used to ensure the confidentiality and security of the order process. The invention is not limited to a particular embodiment, but extends to various substitutions, modifications, combinations, and permutations that nevertheless fall within the scope and spirit of the appended claims.

What is claimed is:

1. A system for purchasing customized capital equipment in an online marketplace environment, the system comprising:
a business-to-business exchange web page including basic product information for a plurality of capital equipment products;
at least one link included in the exchange web page for punching through from the exchange web page to a product provider web page;
means for presenting a price quotation for a capital equipment product; and
an acceptance module configured for enabling acceptance of the price quotation at the exchange web page.

2. The system of claim 1, wherein the capital equipment products include medical equipment systems.

3. The system of claim 1, wherein the price quotation is generated by a product provider.

4. The system of claim 1, wherein the price quotation is generated using a product configurator.

5. The system of claim 1, wherein the price quotation is based on unique customer requirements.

6. The system of claim 1, wherein the product provider web page includes means for receiving customer requirements for the capital equipment product.

7. The system of claim 1, further comprising means for communicating the price quotation acceptance to a product provider.

8. The system of claim 7, wherein the means for communicating includes means for triggering a price quotation acceptance at the product provider web page.

9. The system of claim 7, wherein the means for communicating includes means for sending a notification to the product provider

10. The system of claim 1, wherein the at least one link is a hyperlink to the product provider web page.

11. The system of claim 1, further comprising means for automatically eliciting purchaser requirements for use in generating the price quotation.

12. A system for allowing purchases of customized capital equipment in a marketplace environment, the system comprising:
a business-to-business exchange web page including basic product information for at least one product and at least one link to a product provider web page;
means for presenting a price quotation from a product provider at the exchange web page; and
means for accepting the price quotation at the exchange web page.

13. The system of claim 12, wherein the product is a medical equipment system.

14. The system of claim 12, wherein the customized price quotation is generated by a product provider.

15. The system of claim 12, wherein the price quotation is generated using a product configurator.

16. The system of claim 12, wherein the customized price quotation is based on unique customer requirements.

17. The system of claim 12, wherein the exchange web page includes means for receiving customer requirements for use in generating the customized price quotation.

18. The system of claim 12, further comprising means for communicating the acceptance to the product provider.

19. The system of claim 18, wherein the means for communicating includes triggering a price quotation acceptance at the product provider web page.

20. The system of claim 18, wherein the means for communicating includes means for sending a notification to the product provider.

21. The method of claim 18, further providing automatically generating a series of questions designed to elicit purchaser requirements and displaying the questions to a purchaser.

22. A method for purchasing customized capital equipment products in an electronic marketplace, the method comprising:
viewing basic product information for a plurality of capital equipment products at a business-to-business exchange;
providing customer specifications for a customized capital equipment product to a product provider;
viewing a price quotation for the customized capital equipment product; and
accepting the price quotation at the business-to-business exchange.

23. The method of claim 22 wherein the customized capital equipment product is a medical system.

24. The method of claim 22, wherein the step of viewing basic product information comprises viewing a business-to-business exchange web page using a web browser.

25. The method of claim 22, further comprising punching through to a product provider web page.

26. The method of claim 22, wherein the step of providing customer specifications comprises answering a series of questions regarding customer requirements.

27. The method of claim 26, wherein at least a portion of the questions may be answered at the provider web page.

28. The method of claim 22, wherein viewing the price quotation takes place at the exchange web page.

29. The method of claim 22, further comprising communicating the acceptance to the product provider.

30. The method of claim 29, wherein communicating the acceptance includes triggering an acceptance at the product provider web page.

31. The method of claim 29, wherein communicating the acceptance includes sending a notification to the product provider.

32. The method of claim 29, further providing automatically generating a series of questions designed to elicit purchaser requirements and displaying the questions to a purchaser.

33. A method for enabling purchases of customized capital equipment in a marketplace environment, the method comprising:
displaying basic product information for a plurality of products at a business-to-business exchange web page;
providing at the exchange web page a link to a price quotation for a capital equipment product; and
receiving an acceptance of the price quotation at the exchange web page.

34. The method of claim 33, further comprising communicating the acceptance to a product provider.

35. The method of claim 34, wherein communicating the acceptance comprises triggering an acceptance at a product provider web page.

36. The method of claim 34, wherein communicating the acceptance comprises sending a notification to the product provider.

37. The method of claim 33, wherein the price quotation is generated by a product provider.

38. The method of claim 33, wherein the price quotation is generated using a product configurator.

39. The method of claim 33, wherein the price quotation is based on unique customer requirements.

40. The method of claim 33, further providing automatically generating a series of questions designed to elicit purchaser requirements and displaying the questions to a purchaser.

41. A method for enabling purchases of customized capital equipment in a marketplace environment, the method comprising:
displaying basic product information for a capital equipment product at a business-to-business exchange;
providing at the exchange a link to a customized price quotation for a capital equipment product;
receiving an acceptance of the price quotation at the exchange; and
communicating the acceptance to a product provider.

42. The method of claim 41, wherein the price quotation is generated by a product provider.

43. The method of claim 41, wherein the price quotation is generated using a product configurator.

44. The method of claim 41, wherein communicating the acceptance comprises triggering an acceptance at a product provider web page.

45. The method of claim 41, wherein communicating the acceptance comprises sending a notification to the product provider.
